(19) United States
(12) Patent Application Publication
(10) Pub. No.: US 2021/0070538 A1
(43) Pub. Date: Mar. 11, 2021

(54) PAPER CARTRIDGE FOR EXTRACTING BEVERAGE AND MANUFACTURING METHOD THEREFOR

(71) Applicant: Woo Yeon Jung, Seoul (KR)

(72) Inventor: Woo Yeon Jung, Seoul (KR)

(21) Appl. No.: 16/950,105

(22) Filed: Nov. 17, 2020

Related U.S. Application Data
(63) Continuation of application No. PCT/KR2019/013532, filed on Oct. 15, 2019.

(30) Foreign Application Priority Data
Dec. 12, 2018 (KR) 10-2018-0160055

(51) Int. Cl. B65D 85/804; B65B 29/02

(52) U.S. Cl. CPC B65D 85/8046; B65B 29/025

(57) ABSTRACT

A paper cartridge for extracting a beverage and a method for manufacturing the cartridge are proposed. The paper cartridge is configured to extract a beverage including not only general tea-type beverages such as green tea, black tea, and Solomon's seal tea, but also medicinal herbal tea-type beverages such as Angelica gigas Nakai, Eucommia ulmoides Oliv., Liriope muscari, Saengmaek-san, Acanthopanax Root Bark, Schisandra chinensis, Arctium lappa, Panax ginseng, Hovenia dulcis, and red ginseng by using high-pressure extraction water after the paper cartridge is fitted over a beverage maker. More specifically, proposed are an environment-friendly paper cartridge and a manufacturing method therefor, in which a pod-shaped body, a porous inner filter, and a cover sheet are all made of paper materials and are bonded to each other via a medium including a synthetic resin component by a hot-pressing method, thereby preventing environmental pollution.

### TECHNICAL FIELD

The present disclosure relates generally to a paper cartridge for extracting a beverage including not only general tea-type beverages such as green tea, black tea, and Solomon's seal tea, but also medicinal herbal tea-type beverages such as Angelica gigas Nakai, Eucommia ulmoides Oliv., Liriope muscari, Saengmaek-san, Acanthopanax Root Bark, Schisandra chinensis, Arctium lappa, Panax ginseng, Hovenia dulcis, and red ginseng by using high-pressure extraction water after the paper cartridge is fitted over a beverage maker. More specifically, the present disclosure relates to an environment-friendly paper cartridge and a manufacturing method therefor, in which a pod-shaped body, a porous inner filter, and a cover sheet are all made of paper materials and are bonded to each other via a medium including a synthetic resin component by a hot-pressing method, thereby preventing environmental pollution.

### BACKGROUND ART

Generally, as daily and social life progresses and becomes specialized, numerous devices that can be used simply and efficiently are being developed, and a coffee maker is one of the devices that can be used simply and efficiently.

Such a coffee maker extracts coffee by injecting hot water having atmospheric or high pressure into sealed space in a capsule-type cartridge in which coffee powder or coffee liquid is stored, and thus can be used very easily and simply. Unlike normal powdered coffee, the coffee maker produces the unique taste and aroma of coffee having quality higher than the quality of drip coffee or coffee extracted under normal pressure in open space and is conveniently used.

For the coffee maker, various types of cartridges have been developed and used according to the type and form of coffee.

Meanwhile, as interest in normal tea such as green tea and black tea instead of coffee or in medicinal herbal tea such as red ginseng and Panax ginseng is increased due to change in perception of health, products that enable easy and convenient drinking of these various types of beverages are being developed.

There is a representative tea bag allowing the easy and convenient drinking of these tea types of beverages.

A tea bag is a pouch made of a rough cotton, filter paper, or a nylon sieve in which coffee, tea leaves, or powdered tea is contained, and without the need of the use of a separate beverage maker, is leached in hot water (or cold water) such that tea is extracted, and thus is used by many people.

A tea bag is easily used, but has a limitation in adding the unique taste and aroma of a beverage. Accordingly, interest in products which can extract all kinds of beverages while having good taste and aroma as a cartridge used in a coffee maker does is rising.

A technology that can extract beverages by storing all kinds of beverages including coffee in the form of powder in a cartridge that is conveniently used has been developed. All kinds of cartridges currently on the market are made of plastic, and thus have a huge negative impact on environment.

For reference, as prior arts for such a cartridge for extracting a beverage, there are “a capsule for extracting beverage” disclosed in Korean Patent No. 10-1215532 and “a capsule and a beverage extracting method using the same” disclosed in Korean Patent Application Publication No. 10-2012-0113892.

The prior arts are technologies allowing beverage powder in the cartridge to be extracted as a liquid beverage by high-pressure hot water after the beverage powder is stored in the capsule-type cartridge, such as a coffee cartridge, and allow various types of beverages to be extracted by a beverage maker such as the coffee maker and to be consumed.

However, a conventional cartridge made of soft plastic has beverage powder sealed therein and thus is impossible to be recycled, and after used, the plastic cartridge is required to be disposed by being buried or incinerated, so the conventional cartridge is not suitable for the eco-friendly era.

### DISCLOSURE

### Technical Problem

Accordingly, the present disclosure has been proposed to solve the above problems, and

the present disclosure is intended to propose a paper cartridge for extracting a beverage and a manufacturing method therefor in which a cartridge used to extract not only general tea-type beverages such as green tea, black tea, and Solomon's seal tea including coffee, but also medicinal herbal tea-type beverages such as Angelica gigas Nakai, Eucommia ulmoides Oliv., Liriope muscari, Saengmaek-san, Acanthopanax Root Bark, Schisandra chinensis, Arctium lappa, Panax ginseng, Hovenia dulcis, and red ginseng is made of an eco-friendly paper material to prevent environmental pollution and the generation of environmental hormones, and a body, an inner filter, and a double cover sheet which are made of paper materials are securely bonded to each other to have multiple layers and are sealed, and

the present disclosure is intended to propose a paper cartridge for extracting a beverage and a manufacturing method therefor in which a sealing structure using a paper material is efficiently designed, and due to the characteristic of the paper material itself, the inner pressure of the cartridge can be automatically controlled by the injection of hot or cold water.

In addition, the present disclosure is intended to propose a paper cartridge for extracting a beverage and the manufacturing method therefor in which during the extraction of the beverage, the perforating of a first bottom part is not performed in a state in which the cover sheet is perforated such that the extraction pressure of a storage part is increased, and at an expansion critical point of each of a second bottom part and the first bottom part after the second bottom part and the first bottom part expand convexly downward due to the increase of the pressure, the first bottom part is perforated and the beverage is discharged, whereby the flavor of a beverage, particularly, such as espresso, whose taste and aroma are improved during high pressure extraction, is enhanced.

### Technical Solution

In order to accomplish the above objectives, a paper cartridge for extracting a beverage according to the present disclosure includes:

a pod-shaped body having a first bottom part and a first side wall part constituting a receiving part, and a flange part formed by protruding along a circumference of an upper open part of the first side wall part;

a porous inner filter having a second bottom part and a second side wall part constituting a storage part in which beverage powder is stored, an upper end of the second side wall part being bonded to an upper end of the first side wall part;

a cover sheet bonded to the flange part of the body and sealing the body; and

a medium bonding the inner filter and the cover sheet to the body,

wherein the body, the porous inner filter, and the cover sheet are made of paper materials, and

the medium includes a synthetic resin component for thermal bonding, so the body, the inner filter, and the cover sheet made of the paper materials are bonded to each other via the medium by a hot-pressing method.

In addition, in the paper cartridge for extracting a beverage according to the present disclosure,

a height of the second side wall part of the inner filter may be shorter than a height of the first side wall part, so space may be defined between the first bottom part and the second bottom part, and

during the extraction of the beverage, in a state in which an upper perforating means of a beverage maker completely perforates the cover sheet, the first bottom part may not be completely perforated by a lower perforating means of the beverage maker, so the beverage extracted to the space temporarily may stay in the space and discharging of the beverage may be delayed for a predetermined period of time.

Furthermore, in the paper cartridge for extracting a beverage according to the present disclosure,

the second bottom part and the first bottom part may expand convexly downward due to increase of pressure of each of the storage part and the space during the extraction of the beverage, and at an expansion critical point of each of the second bottom part and the first bottom part, the first bottom part may be completely perforated by the lower perforating means, so the beverage in the space may be discharged.

Additionally, in the paper cartridge for extracting a beverage according to the present disclosure,

the body may include a support part having a support groove formed under the first bottom part in such a manner that the first side wall part is connected to the first bottom part with a lower end of the first side wall part extending toward a lower side of the first bottom part.

In addition, in the paper cartridge for extracting a beverage according to the present disclosure,

the second side wall part of the inner filter may be configured to have the height shorter than the height of the first side wall part, so the space may be defined between the first bottom part and the second bottom part,

Furthermore, in the paper cartridge for extracting a beverage according to the present disclosure,

in the inner filter, the second side wall part may be formed to have a pleated shape.

Additionally, in the paper cartridge for extracting a beverage according to the present disclosure,

the porous inner filter may include a protrusion part formed at the upper end of the second side wall part, the protrusion part protruding toward an upper part of the flange part, so during the bonding of the cover sheet, the protrusion part may be placed between the flange part and the cover sheet and be bonded thereto together with the medium.

In addition, the manufacturing method of the paper cartridge for extracting a beverage according to the present disclosure,

the paper cartridge including: the pod-shaped body having the first bottom part and the first side wall part constituting the receiving part, and the flange part formed by protruding along a circumference of an upper open part of the first side wall part;

the porous inner filter having the second bottom part and the second side wall part constituting the storage part in which beverage powder is stored, an upper end of the second side wall part being bonded to an upper end of the first side wall part;

the cover sheet bonded to the flange part of the body and sealing the body; and

the medium bonding the inner filter and the cover sheet to the body,

wherein the body, the porous inner filter, and the cover sheet are made of paper materials, and

the medium includes the synthetic resin component for thermal bonding, so the body, the inner filter, and the cover sheet made of the paper materials are bonded to each other via the medium by the hot-pressing method,

the manufacturing method including: a) preparing each of the pod-shaped body, the porous inner filter, and the cover sheet which are made of the paper materials, and the medium and an adhesive sheet which comprise the synthetic resin component for thermal bonding;

b) bonding contacting portions of the upper ends of the first side wall part of the body and the second side wall part of the inner filter to each other by applying heat and pressure thereto after fitting the inner filter into the receiving part of the body;

c) storing the beverage powder in the storage part of the inner filter; and

d) sealing the cartridge by bonding contacting portions of the flange part and the cover sheet to each other by applying heat and pressure thereto after covering the flange part of the body with the adhesive sheet and covering the adhesive sheet with the cover sheet.

### Advantageous Effects

According to the paper cartridge for extracting a beverage and the manufacturing method therefor according to the present disclosure,

the cartridge storing the beverage powder of general tea-type beverages such as green tea, black tea, and Solomon's seal tea, and of medicinal herbal tea-type beverages such as Angelica gigas Nakai, Eucommia ulmoides Oliv., Liriope muscari, Saengmaek-san, Acanthopanax Root Bark, Schisandra chinensis, Arctium lappa, Panax ginseng, Hovenia dulcis, and red ginseng is made of a paper material, thereby preventing environmental pollution due to the use of the eco-friendly paper cartridge, and preventing environmental hormones from being released by hot water during the extraction of the beverage without the use of separate adhesive,

the medium including the synthetic resin component for thermal bonding is used instead of adhesive, and the body, the inner filter, and the cover sheet which are made of paper materials are securely bonded to each other via the medium by a hot-pressing method, thereby preventing the damage of the cover sheet and the deformation of the body and the inner filter during the extraction of a beverage, and

manufacturing costs are reduced due to the production of the paper cartridge, thereby having price competitiveness.

In addition, according to the paper cartridge for extracting a beverage and the manufacturing method therefor according to the present disclosure,

during the extraction of a beverage, the first bottom part is not perforated in a state in which the cover sheet is perforated such that extraction pressure in the storage part is increased, and thus at the expansion critical point of each of the second bottom part and the first bottom part, the first bottom part is perforated and the beverage is discharged, thereby further enhancing the flavor of a beverage, particularly, such as espresso, whose taste and aroma are improved during high pressure extraction.

Particularly, according to the paper cartridge for extracting a beverage and the manufacturing method therefor according to the present disclosure,

the support part protrudes toward the lower side of the circumference of the first bottom part, and during the extraction of a beverage, a perforating pin protruding at the bottom of the cartridge mounting part of the beverage maker does not completely perforate an extraction hole of the first bottom part (more preferably, only approximately 30% of the original size of the extraction hole), and in a state in which the first bottom part is expanded and the inner pressure of the space is increased during the normal pressure or high pressure injection of hot or cold water, the expanded first bottom part is completely (100%) perforated, thereby providing the extraction effect of a beverage having higher concentration.

### DESCRIPTION OF DRAWINGS

FIG. 1 is a sectional view of a paper cartridge according to the present disclosure.

FIG. 2 is a perspective view of the exterior of the paper cartridge according to the present disclosure.

FIG. 3 is a first exploded perspective view of the paper cartridge according to the present disclosure.

FIG. 4 is a block diagram of the manufacturing method of the paper cartridge according to the present disclosure.

FIG. 5 is a sectional view roughly illustrating a step-by-step beverage extraction by using the paper cartridge according to the present disclosure.

<Description of the Reference Numerals in the Drawings>

| | |
|---|---|
| 10: Body | 11: Receiving part |
| 12: First bottom part | 13: First side wall part |
| 14: Flange part | 15: Support groove |
| 16: Support part | 20: Inner filter |
| 21: Storage part | 22: Second bottom part |
| 23: Second side wall part | 30: Cover sheet |
| 40: Adhesive sheet | |

### BEST MODE

A paper cartridge of the present disclosure will be described in detail based on an aspect (or an embodiment). The present disclosure may, however, be embodied in many different forms and should not be construed as being limited to only the embodiments set forth herein, but should be construed as covering modifications, equivalents or alternatives falling within ideas and technical scopes of the present disclosure.

In each drawing, like reference numerals, particularly, tens and units, or reference numerals having like tens, units and letters refer to like elements having like functions throughout, and unless the context clearly indicates otherwise, elements referred to by reference numerals of the drawings should be understood based on this standard.

In addition, for convenience of understanding of the elements, in the figures, sizes or thicknesses may be exaggerated to be large (or thick), may be expressed to be small (or thin), or may be simplified for clarity of illustration, but due to this, the protective scope of the present disclosure should not be interpreted narrowly.

The terminology used herein is for the purpose of describing particular aspects (or embodiments) only and is not intended to be limiting of the present disclosure. As used herein, the singular forms are intended to include the plural forms as well, unless the context clearly indicates otherwise.

It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

Terms such as ‘a first ˜’ and ‘a second ˜’ are used only for the purpose for distinguishing a constitutive element from other constitutive element, but a constitutive element should not be limited to a manufacturing order, and the terms described in the detailed description of the embodiment may not be consistent with those described in the claims.

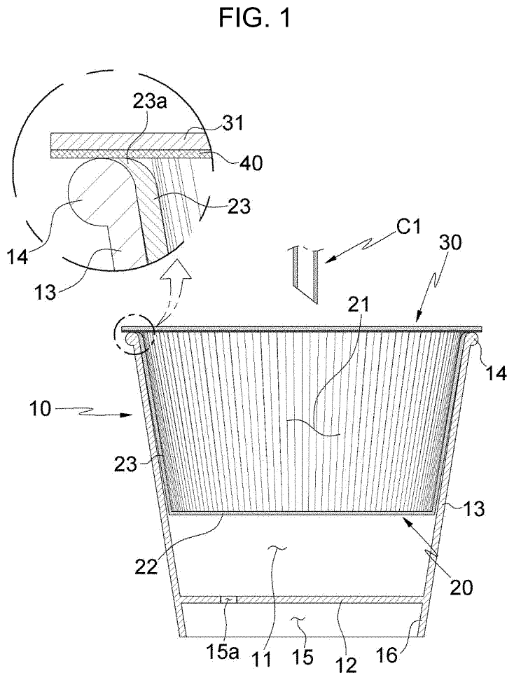

When an approximate directional standard is determined referring to FIG. 1 for convenience in describing a paper cartridge for extracting a beverage and the manufacturing method therefor according to the present disclosure, a direction in which gravity acts is a lower side. Further, an upper side, a lower side, a left side, and a right side will be determined by the directions in the drawings, and unless otherwise defined, a detailed description of the embodiment and claims in relation to the other drawings will be described based on the standard.

Hereinafter, the paper cartridge for extracting a beverage and the manufacturing method therefor according to the present disclosure will be described with reference to the accompanying drawings.

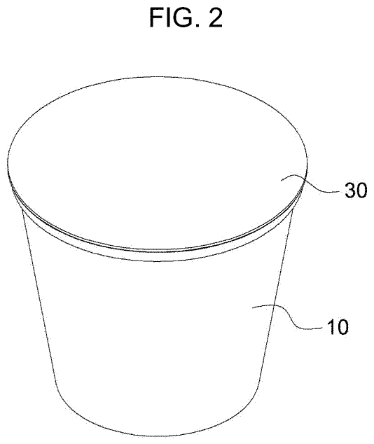

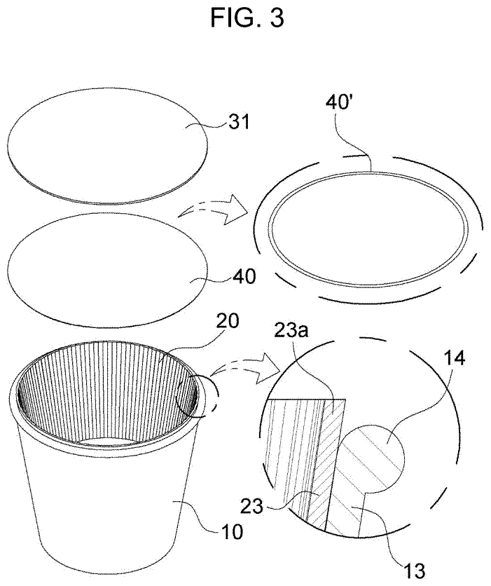

First, as illustrated in FIGS. 1 to 3, the paper cartridge for extracting a beverage according to the present disclosure largely includes: a pod-shaped body 10 constituting the entire exterior of the cartridge; a porous inner filter 20 in which the beverage powder is stored; a cover sheet 30 sealing the body 10; and a medium bonding the inner filter 20 and the cover sheet 30 to the body 10.

The pod-shaped body 10 includes a first bottom part 12 and a first side wall part 13 constituting a receiving part 11, and a flange part 14 formed by protruding along the circumference of the upper open part of the first side wall part 13.

In addition, the porous inner filter 20 includes a second bottom part 22 and a second side wall part 23 constituting a storage part 21 in which the beverage powder is stored, the upper end of the second side wall part 23 being bonded to the inner surface of the upper end of the first side wall part 13.

Furthermore, the cover sheet 30 is bonded to the flange part 14 of the body 10 and seals the body 10.

In this case, in the present disclosure, the body 10, the porous inner filter 20, and the cover sheet 30 are made of paper materials;

the medium includes a synthetic resin component for thermal bonding; and the body 10, the inner filter 20, and the cover sheet 30 which are made of the paper materials are bonded to each other via the medium by a hot-pressing method.

In the present disclosure, the inclusion of the synthetic resin component for thermal bonding as the medium means,

that each of the paper materials includes a predetermined amount of synthetic resin (for example, PP), or

is manufactured to have the synthetic resin for thermal bonding applied to or coated thinly on the surface of the paper material

so that the synthetic resin for thermal bonding is melted by heating and the melted synthetic resin allows the paper materials to be bonded to each other by compressing. That is, the inclusion of the synthetic resin component means that without adhesive, the synthetic resin component as the medium allows the body 10, the inner filter 20, and the cover sheet 30 to be bonded to each other.

In this case, as described above, the medium may be only the synthetic resin component included in the paper material in various methods, or may be configured as an adhesive sheet 40 including the synthetic resin component for thermal bonding as described later.

In addition, when the synthetic resin component is included in the paper material, a portion of the paper material having the synthetic resin component is limited to a portion of the upper end of the inner surface of the first side wall part 13 and the upper surface of the flange part 14 in the case of the body 10, to a portion of the upper end of the outer surface of the second side wall part 23 in the case of the inner filter 20, and to a portion of the edge part of the lower surface of the cover sheet in the case of the cover sheet 30, whereby the synthetic resin functioning as adhesive is not exposed to the storage part 21 storing the beverage powder and to the lower space of the receiving part 11 to which the extracted beverage is discharged while forming vortexes.

Particularly, the body 10 has a shape of a capsule (or pod), and has the receiving part 11 formed therein, the receiving part being constituted by the first bottom part 12 and the first side wall part 13, and the flange part 14 formed by protruding outward from the upper end part of the first side wall part 13 along the circumference of the upper open part of the body 10,

wherein the upper open part of the body 10 is sealed by bonding the cover sheet 30 to the flange part 14 of the body 10 while the inside of the body is in a vacuum state as much as possible.

Such a cartridge may vary in the size or shape of the receiving part 11, that is, of the body 10 according to the specification of each manufacturer of a beverage maker.

In addition, the body 10 includes a support part 16 having a support groove 15 formed under the first bottom part 1 in such a manner that the first side wall part 13 is connected to the first bottom part 12 with the lower end of the first side wall part extending toward the lower side of the first bottom part 12.

When the cartridge is mounted to the beverage maker, a lower perforating means (not shown) of the beverage maker is inserted into the support groove 15 formed by the support part 16 and perforates the first bottom part 12 to form a beverage extraction hole 15a. In this case, the first bottom part 12 is fitted over a cartridge fitting part (not shown) having the lower perforating means such that the cartridge is mounted to the beverage maker.

In addition, although there is no limitation in the number and position of the beverage extraction hole 15a, the beverage extraction hole 15a is perforated to be adjacent to the edge of the first bottom part 12. Accordingly, during the extraction of a beverage, the beverage is not discharged directly from the lower space of the receiving part 11, but after forming vortexes while staying therein for a predetermined period of time, is discharged through the beverage extraction hole 15a, whereby the taste and aroma of the beverage can be enhanced.

Next, like filter paper used for drip coffee, the porous inner filter 20 includes multiple fine extraction holes through which the beverage powder cannot pass but only liquid beverages can pass, and is composed of the second bottom part 22 and the second side wall part 23 forming a shape of a pocket made of a rough cotton, filter paper, a nylon sieve, or non-woven fabric. The beverage powder is stored in the storage part 21 of the inner filter 20 sealed by the cover sheet 30 after the second side wall part 23 of the inner filter 20 is bonded to the upper end of the inner surface of the first side wall part 13 of the body 10.

Such an inner filter 20 is required to be configured such that the beverage powder is not discharged to the receiving part 11 of the body 10. The second side wall part 23 is configured to have height shorter than the height of the first side wall part 13 such that space is defined between the first bottom part 12 and the second bottom part 22.

Here, defining the space between the first bottom part 12 and the second bottom part 22 means defining empty space between the inner filter 20 and the body 10 such that a beverage extracted by passing through the inner filter 20 is not discharged directly to the beverage extraction hole 15a of the body 10 but after staying in the receiving part 11 for a predetermined period of time, is discharged through the beverage extraction hole 15a.

In this case, due to the space defined between the inner filter 20 and the body 10, the beverage passing through the inner filter 20 is not directly discharged, but stays in the space. Accordingly, while extraction water allowed to be supplied continuously for a predetermined period of time by an upper perforating means C1 stays for a sufficient period of time in the inner filter 20, leaching or dissolution of the beverage powder is performed, thereby enhancing the taste and aroma of the beverage.

In addition, when the paper cartridge of the present disclosure is fitted over the beverage maker (before injecting hot water for beverage extraction), as required, the perforating pin of the upper perforating means C1 or the perforating pin of the lower perforating means C2, or both of the upper perforating means C1 and the lower perforating means C2

are spaced apart from the cover sheet 30 or the first bottom part 12, respectively, and perform perforating thereof by the manipulation of the beverage maker,

are in contact with the cover sheet 30 or the first bottom part 12, respectively, and perform perforating thereof by the manipulation of the beverage maker,

perforate a portion of the cover sheet 30 or the first bottom part 12, respectively, and perform a complete perforating thereof by being additionally introduced thereinto by the manipulation of the beverage maker, or

completely perforate the cover sheet 30 or the first bottom part 12, respectively such that the beverage extraction is directly performed, and in this state, are additionally introduced thereinto by a further manipulation of the beverage maker,

whereby the perforating of the paper cartridge can be performed.

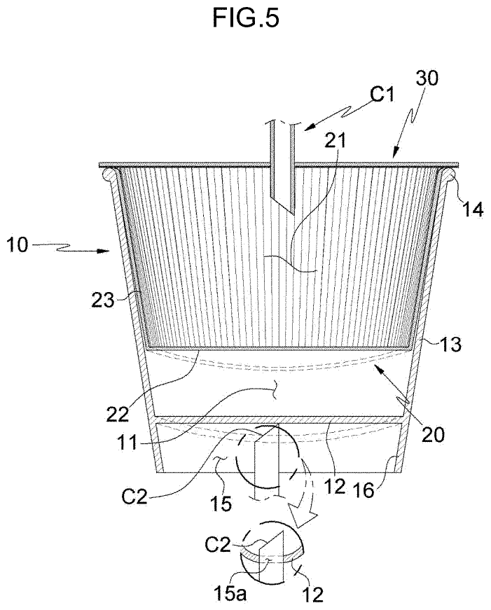

Particularly, as illustrated in FIG. 5, in the paper cartridge of the present disclosure, during the extraction of a beverage, in a state in which the upper perforating means C1 of the beverage maker completely perforates the cover sheet 30, the first bottom part 12 is not completely perforated by the lower perforating means C2 of the beverage maker, so the beverage extracted to the space stays temporarily in the space such that the discharging of the beverage is delayed for a predetermined period of time.

Here, the state in which the first bottom part 12 is not completely perforated includes a state in which the first bottom part 12 is not in contact with the perforating pin of the lower perforating means C2, and a state in which the opposite surfaces of the first bottom part 12 are not completely perforated but only a portion of the lower surface of the first bottom part 12 is perforated with the first bottom part 12 being in contact with the perforating pin, when the cartridge is lowered by the operation of the beverage maker.

Furthermore, a case in which a small amount of beverage is discharged in a state in which the rising of the perforating pin or the expansion of the first bottom part 12 is not completed although the perforating pin of the lower perforating means C2 partially perforates the first bottom part 12 should be understood as the delaying of the discharging of the beverage due to the partial perforating of the first bottom part 12. That is, the state in which the first bottom part is not completely perforated includes a state in which a small amount (or a very small amount) of the beverage is discharged and the discharging of the remaining amount of the beverage is delayed in the space in a state in which the beverage extraction hole 15a is perforated to have size (approximately 30% of an original size thereof) smaller than the original size of the extraction hole.

In this case, as the method of preventing the first bottom part from being completely perforated for a predetermined period of time in a state in which the cover sheet 30 is perforated, a method of making the ascending speed of the perforating pin of the lower perforating means C2 slower than the descending speed (time) of the perforating pin of the upper perforating means C1, or a method of setting the ascending height of the perforating pin of the lower perforating means C2 to at least two levels may be considered.

Accordingly, when the perforating of the first bottom part 12 is performed slower than the perforating of the cover sheet 30, the beverage rises in the space and pressure in the space rises. Accordingly, in reaction thereto, the downward expansion of the second bottom part 22 due to the injection pressure of the extraction water and the decrease of pressure in the storage part due to the increase of the volume of the storage part 21 are prevented, thereby providing the same effect as increasing extraction pressure in the storage part 21.

In addition, during the extraction of a beverage, the second bottom part 22 and the first bottom part 12 expand convexly downward due to the increase of pressure of each of the storage part 21 and the space, and at an expansion critical point of each of the second bottom part and the first bottom part, the first bottom part 12 is completely perforated by the lower perforating means C2, so the beverage in the space is discharged.

That is, as described above, the expansion of the second bottom part 22 is restrained due to the increase of pressure in the space, but there is limitation in the restraint of the expansion. Particularly, as the injection of the extraction water continues, the pressure in the storage part 21 becomes larger than the pressure in the space. Accordingly, the injection pressure of the extraction water is applied to the inside of each of the storage part 21 and the space, so the second bottom part 22 and the first bottom part 12 are expanded convexly downward.

In this case, in a state in which the first bottom part 12 is in contact with the perforating pin of the lower perforating means C2, the first bottom part is not perforated immediately due to the unique transformation force of the paper material itself, and the sealed state of the space is maintained. Accordingly, during the expansion of each of the second bottom part 22 and the first bottom part 12, the extraction water and the beverage fill the inside of each of the storage part 21 and the space, and then the first bottom part 12 reaches the expansion critical point.

When the first bottom part 12 reaches the expansion critical point, the beverage extraction hole 15a of the first bottom part 12 is completely (100%) perforated by the perforating pin of the lower perforating means C2 as illustrated in a sectional view in a circle of a lower side of FIG. 5, and the inner pressure of the space is released, so the state of the first bottom part is restored to an original flat state thereof. In this case, the beverage in the storage part 21 passes through the space and is discharged to the beverage extraction hole 15a.

When the beverage is discharged in the downward convex state of the first bottom part 12, due to the increase of pressure described above, the extraction pressure of the inside of each of the storage part 21 and the space can be maintained at high pressure having at least predetermined pressure, so extraction efficiency or quality compared to the period of the same extraction time is improved, thereby enhancing the flavor of a beverage, such as espresso, whose taste and aroma are improved during high pressure extraction.

In addition, when the beverage extraction hole 15a is formed in the first bottom part 12 in the downward convex state, particularly, when the beverage extraction hole 15a is formed at the lowest point of the first bottom part 12, the beverage in the space can be completely discharged to the beverage extraction hole 15a.

In this case, as for the method of allowing the first bottom part 12 to reach the expansion critical point earlier than the second bottom part 22, the first bottom part 12 is configured to have thickness thicker than the thickness of the second bottom part 22 so as to add rigidity to the first bottom part 12, whereby while the second bottom part 22 thinner than the first bottom part 12 resists against the expansion pressure of the storage part due to ductility of the second bottom part, the first bottom part 12 thicker than the second bottom part 22 can allow the beverage extraction hole 15a to be formed due to the increased rigidity and the pressing of the perforating pin before the second bottom part 22 bursts.

The extraction water performing the leaching and dissolution of beverage powder in the inner filter 20 through sequential perforating of the cover sheet 30 and the first bottom part 12 after restraining the expansion of each of the first and second bottom parts 12 and 22 has a sufficient extraction time in the high-pressure state of the extraction water and is finally discharged as a liquid beverage.

In addition, the second side wall part 23 of the inner filter 20 is formed to have a pleated shape such that the inner filter 20 is prevented from being expanded and damaged during the increase of a beverage extraction area and the high-pressure injection of hot water.

The second side wall part 23 having the pleated shape can also prevent the second bottom part 22 from being damaged before the first bottom part 12 is perforated.

Furthermore, the porous inner filter 20 includes a protrusion part 23a formed at the upper end of the second side wall part 23, the protrusion part protruding toward the upper part of the flange part 14, so during the bonding of the cover sheet 30, the protrusion part 23a is placed between the flange part 14 and the cover sheet 30 and is bonded thereto together with the medium, particularly, with the adhesive sheet 40 to be described later.

Accordingly, the reason in which the protrusion part 23a which is minute is formed and is placed between the flange part 14 and the cover sheet 30 to be bonded to thereto is to improve the adhesive force of the inner filter 20 via the protrusion part 23a such that during the injection of high-pressure hot water into the cartridge, the inner filter 20 is prevented from being separated from the body 10 due to the injection pressure.

In addition, the protrusion part 23a bonded in this way improves airtightness between the flange part 14 and the cover sheet 30 together with the adhesive sheet 40 as the medium to be described later, whereby the deterioration of the beverage powder is prevented, and hot water is prevented from leaking to a minute gap between the flange part 14 and the cover sheet 30. In this case, due to the second side wall part 23 having the pleated shape, the protrusion part 23a is also compressed and bonded by being pleated, thereby providing more excellent airtightness.

In addition, the cover sheet 30 is bonded to the flange part 14 and seals the body 10, that is, the storage part 21 of the inner filter 20.

The cover sheet 30 is a cardboard thicker than the adhesive sheet 40 to be described later. The cover sheet 30 and the adhesive sheet 40 have areas corresponding to each other. Particularly, the cover sheet 3 is made of a pure paper material which does not include the synthetic resin component, and the adhesive sheet 40 is made of a special paper material which includes the synthetic resin component, whereby the adhesive sheet 40 placed between the cover sheet 30 and the flange part 14 functions as adhesive.

In this case, the adhesive sheet 40 may be made of only synthetic resin having the shape of a thin vinyl, but manufacturing the adhesive sheet of the special paper material as in the manufacturing of the body 10 and the inner filter 20 is more suitable for the purpose of manufacturing an eco-friendly paper cartridge.

In addition, the adhesive sheet 40 may be cut in a shape of a circular plate corresponding to the cover sheet 30 and in a shape of the edge of the cover sheet 30, that is, a shape of a cardboard having a ring shape corresponding to the flange part 14. In the case of the adhesive sheet 40′ having such a shape of a ring, the adhesive sheet is bonded to the flange part 14 and the cover sheet 30 in a state of being hidden therebetween, so the exposing area of the synthetic resin can be reduced.

When a hot water injection hole is perforated in the cover sheet made of a paper material by the upper perforating means C1, remaining portions of the cover sheet except for the hot water injection hole are prevented from being torn. Furthermore, due to the bonding of the pleated protrusion part 23a of the inner filter 20 described above, the airtightness of the cover sheet 30 is increased, which maximally prevents the cover sheet 30 from being swollen and being damaged by high-pressure hot water during the extraction of a beverage.

Next, the manufacturing method of a paper cartridge for extracting a beverage having the above configuration will be described.

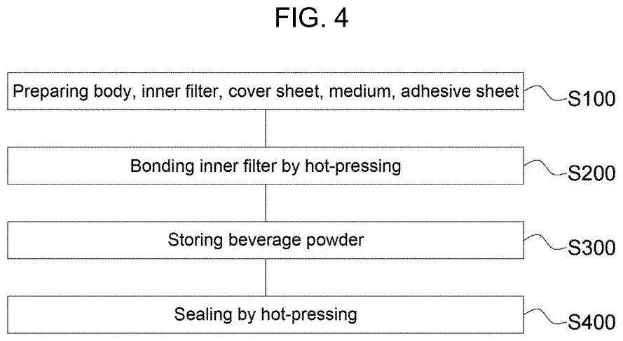

As illustrated in FIGS. 1 to 4, the manufacturing method of a paper cartridge according to the present disclosure includes:

a) preparing each of the pod-shaped body 10, the porous inner filter 20, and the cover sheet 30 which are made of paper materials, the medium and an adhesive sheet 40 which comprise the synthetic resin component for thermal bonding at S100;

b) bonding contacting portions of the upper ends of the first side wall part 13 of the body 10 and the second side wall part 23 of the inner filter 20 to each other by applying heat and pressure thereto after fitting the inner filter 20 into the receiving part 11 of the body 10 at S200;

c) storing the beverage powder in the storage part 21 of the inner filter 20 at S300; and

d) sealing the cartridge by bonding contacting portions of the flange part 14 and the cover sheet 30 to each other by applying heat and pressure thereto after covering the flange part 14 of the body 10 with the adhesive sheet 40 and covering the adhesive sheet 40 with the cover sheet 30 at S400.

At S100, each of the body 10, the inner filter 20, and the cover sheet 30 is made of only a paper material, and the method of including the synthetic resin component as the medium in the paper material is performed by including the synthetic resin component in the paper material itself, or by applying or coating the synthetic resin component to or on the surface of the paper material.

In addition, the adhesive sheet 40 may be configured as a circular plate or a ring-shaped adhesive sheet 40′ corresponding to the cover sheet 30, and is made of a special paper material including the synthetic resin component as the medium.

In this case, the body 10 manufactured at S100 has a shape of a finished product in which each of the first bottom part 12, the first side wall part 13, the flange part 14, and the support part 16 is completely formed and bonded to each other.

The inner filter 20 has a shape of a circular cardboard having a diameter larger than the inner diameter of the body 10, and is cut to have only an area corresponding to the second bottom part 22 and the second side wall part 23.

The cover sheet 30 has a shape of a circular cardboard having a diameter slightly larger than the diameter of the flange part 14, and is cut separately from the adhesive sheet 40 or 40′.

At S200, the formation and first bonding of the inner filter 20 is performed. First, when the inner filter 20 is pushed and fitted to the inner side of the receiving part 11 by high-pressure air blowing or a pressing unit in a state in which the inner filter 20 having a shape of a cardboard is placed on the flange part 14 of the body 1, the inner filter 20 having the shape of the cardboard is formed to have a shape of a pod having the second bottom part 22 and the second side wall part 23.

A portion of the inner filter 20 which is completely formed in this way is taken out to the open part of the body 10, and the protrusion part 23a is fixed to the upper part of the flange part 14 by protruding theretoward. Next, when the contacting portions of the first side wall part 13 and the second side wall part 23 are heated and compressed by the bonding unit of high-temperature, the inner filter 20 is completely bonded to the body 10 while the synthetic resin as the medium included in each paper material of the body 10 and the inner filter 20 is melted.

In this case, when the inner filter 20 having the shape of the cardboard is formed into the shape of a pod having the second bottom part 22 and the second side wall part 23, the diameter of the inner filter is decreased due to the formation of the second side wall part 23 by bending, so the second side wall part 23 is naturally formed to be pleated.

At S200, the protrusion part 23a is not bent to cover the flange part 14, and protrudes by being connected to the second side wall part 23 on the same line therewith. When the bonding of the inner filter 20 is completed, the protrusion part 23a is pressed outward and is formed by being bent to be in close contact with the upper surface of the flange part 14.

At S300, the beverage powder is put and stored in the storage part 21 of the inner filter 20 bonded to the body 10. As described above, there is no limitation in the type of the beverage powder.

At S400, the cartridge is sealed by the cover sheet 30. First, the adhesive sheet 40 is placed on the upper surface of the flange part 14 and the cover sheet 30 is placed on the adhesive sheet. Next, when the flange part 14 is heated and compressed by the bonding unit, the synthetic resin included in the adhesive sheet 40 is melted and the cover sheet 30 is completely bonded to the body 10.

In this case, at S200, since the protrusion part 23a is formed by being bent to cover the flange part 14, the second side wall part 23 of the inner filter 20 is placed between the flange part 14 and the cover sheet 30 (more precisely, the adhesive sheet 40), and is bonded to the flange part together with the adhesive sheet 40, thereby increasing the adhesive force of the inner filter 20 and the airtightness of the cover sheet 30.

In the paper cartridge having the above structure and manufactured by the method of the present disclosure, an eco-friendly paper material is used without the use of a separate adhesive, so environmental pollution and the generation of environmental hormones are prevented although the paper cartridge is not recycled;

the bonding of the body 10, the inner filter 20, and the cover sheet 30 to each other is very securely maintained, so that the cartridge is prevented from being damaged during the extraction of a beverage and the taste and flavor of a beverage itself are improved, thereby enabling a high-quality beverage to be enjoyed; and

the paper cartridge allows manufacturing costs to be reduced, and thus a good-quality paper cartridge for extracting a beverage can be provided very cheaply, thereby providing excellent price competitiveness compared to a conventional cartridge.

In describing the present disclosure above, the paper cartridge for extracting a beverage has been mainly described with reference to the accompanying drawings, but the present disclosure may be variously modified, changed, and substituted by those skilled in the art. Such modification, change, and substitution should be construed as falling within the scope of the present disclosure.

1. A paper cartridge for extracting a beverage, the paper cartridge comprising:
a pod-shaped body having a first bottom part and a first side wall part constituting a receiving part, and a flange part formed by protruding along a circumference of an upper open part of the first side wall part;
a porous inner filter having a second bottom part and a second side wall part constituting a storage part in which beverage powder is stored, an upper end of the second side wall part being bonded to an upper end of the first side wall part;
a cover sheet bonded to the flange part of the body and sealing the body; and
a medium bonding the inner filter and the cover sheet to the body,
wherein the body, the porous inner filter, and the cover sheet are made of paper materials, and the medium comprises a synthetic resin component for thermal bonding, so the body, the inner filter, and the cover sheet made of the paper materials are bonded to each other via the medium by a hot-pressing method.

2. The paper cartridge of claim 1, wherein a height of the second side wall part of the inner filter is shorter than a height of the first side wall part, so space is defined between the first bottom part and the second bottom part, and during the extraction of the beverage, in a state in which an upper perforating means of a beverage maker completely perforates the cover sheet, the first bottom part is not completely perforated by a lower perforating means of the beverage maker, so the beverage extracted to the space temporarily stays in the space and discharging of the beverage is delayed for a predetermined period of time.

3. The paper cartridge of claim 2, wherein the second bottom part and the first bottom part expand convexly downward due to increase of pressure of each of the storage part and the space during the extraction of the beverage, and at an expansion critical point of each of the second bottom part and the first bottom part, the first bottom part is completely perforated by the lower perforating means, so the beverage in the space is discharged.

4. The paper cartridge of claim 3, wherein the body comprises a support part having a support groove formed under the first bottom part in such a manner that the first side wall part is connected to the first bottom part with a lower end of the first side wall part extending toward a lower side of the first bottom part.

5. The paper cartridge of claim 4, wherein the medium is configured as an adhesive sheet comprising the synthetic resin component for thermal bonding.

6. The paper cartridge of claim 1, wherein in the inner filter, the second side wall part is formed to have a pleated shape.

7. The paper cartridge of claim 1, wherein the porous inner filter comprises a protrusion part formed at the upper end of the second side wall part, the protrusion part protruding toward an upper part of the flange part, so during the bonding of the cover sheet, the protrusion part is placed between the flange part and the cover sheet and is bonded thereto together with the medium.

8. A manufacturing method of a paper cartridge for extracting a beverage, the paper cartridge comprising: a pod-shaped body having a first bottom part and a first side wall part constituting a receiving part, and a flange part formed by protruding along a circumference of an upper open part of the first side wall part; a porous inner filter having a second bottom part and a second side wall part constituting a storage part in which beverage powder is stored, an upper end of the second side wall part being bonded to an upper end of the first side wall part; a cover sheet bonded to the flange part of the body and sealing the body; and a medium bonding the inner filter and the cover sheet to the body, wherein the body, the porous inner filter, and the cover sheet are made of paper materials, and the medium comprises a synthetic resin component for thermal bonding, so the body, the inner filter, and the cover sheet made of the paper materials are bonded to each other via the medium by a hot-pressing method, the manufacturing method comprising:
a) preparing each of the pod-shaped body, the porous inner filter, and the cover sheet which are made of the paper materials, and the medium and an adhesive sheet which comprise the synthetic resin component for thermal bonding;
b) bonding contacting portions of the upper ends of the first side wall part of the body and the second side wall part of the inner filter to each other by applying heat and pressure thereto after fitting the inner filter into the receiving part of the body;
c) storing the beverage powder in the storage part of the inner filter; and
d) sealing the cartridge by bonding contacting portions of the flange part and the cover sheet to each other by applying heat and pressure thereto after covering the flange part of the body with the adhesive sheet and covering the adhesive sheet with the cover sheet.
